(19) United States
(12) Patent Application Publication
(10) Pub. No.: US 2025/0079613 A1
(43) Pub. Date: Mar. 6, 2025

(54) BATTERY PACK CONFIGURED SUCH THAT SELECTIVE SEPARATION OF BATTERY MODULES IS POSSIBLE

(71) Applicant: LG ENERGY SOLUTION, LTD., Seoul (KR)

(72) Inventor: Sang Ok SEON, Daejeon (KR)

(73) Assignee: LG ENERGY SOLUTION, LTD., Seoul (KR)

(21) Appl. No.: 18/287,628

(22) PCT Filed: Mar. 9, 2023
(86) PCT No.: PCT/KR2023/003242

§ 371 Date: Oct. 19, 2023

(30) Foreign Application Priority Data
May 2, 2022 (KR) 10-2022-0054023

(51) Int. Cl. H01M 50/258; H01F 7/02; H01M 10/42; H01M 10/48; H01M 50/204; H01M 50/249; H01M 50/264; H01M 50/269; H01M 50/502; H01M 50/583

(52) U.S. Cl. CPC H01M 50/258; H01M 10/425; H01M 10/482; H01M 10/486; H01M 50/204; H01M 50/249; H01M 50/264; H01M 50/269; H01M 50/502; H01M 50/583; H01F 7/02; H01M 2200/103; H01M 2220/20

(57) ABSTRACT

A battery pack is configured such that selective separation of a plurality of battery modules is possible. The battery pack includes a pack case, a plurality of battery modules received in the pack case, a busbar configured to electrically connect the battery modules to each other, and a module holding unit configured to fix the battery module to the pack case or to separate the battery module from the pack case.

### TECHNICAL FIELD

This application claims the benefit of priority to Korean Patent Application No. 2022-0054023 filed on May 2, 2022, the disclosure of which is incorporated herein by reference in its entirety.

The present invention relates to a battery pack configured such that selective separation of battery modules is possible, and more particularly to a battery pack configured such that selective separation of battery modules is possible, wherein a specific battery module in which fire has broken out or a specific battery module having a high possibility of fire outbreak is separated from the battery pack, whereby it is possible to prevent a major accident, such as explosion.

### BACKGROUND ART

With recent development of alternative energies due to air pollution and energy depletion caused as the result of use of fossil fuels, demand for secondary batteries capable of storing electrical energy that is produced has increased. The secondary batteries, which are capable of being charged and discharged, are intimately used in daily life. For example, the secondary batteries are used in mobile devices, electric vehicles, and hybrid electric vehicles.

Required capacities of secondary batteries used as energy sources of various kinds of electronic devices inevitably used in modern society have been increased due to an increase in usage of mobile devices, increasing complexity of the mobile devices, and development of electric vehicles.

In order to satisfy demand of users, a plurality of battery cells is disposed in a small-sized device, whereas a battery module including a plurality of battery cells electrically connected to each other or a battery pack including a plurality of battery modules is used in a vehicle, etc.

Among secondary batteries, a lithium battery, which is known as having high storage capacity per unit area and being most efficient, is most widely used.

However, heat is inevitably generated in the secondary battery during charging and discharging thereof, and thermal runaway may occur due to short circuit, thermal impact, insulation breakdown, etc. depending on circumstances, which leads to a major accident, such as fire outbreak and explosion.

In particular, it is not easy for a driver to recognize fire outbreak in a vehicle. Furthermore, when fire breaks out, rapid fire extinguishing is difficult, whereby the vehicle may be completely destroyed by fire, and a fatal accident due to explosion may occur.

FIG. 1 is a perspective view of a conventional battery pack assembly. As shown in FIG. 1, the battery pack assembly includes a battery pack 10 having a first magnetic portion 11 and a detachment unit 20 having a second magnetic portion 21, the detachment unit being configured to detach the battery pack, wherein the battery pack is detached by magnetic coupling or release between the first magnetic portion 11 and the second magnetic portion 21.

However, the conventional battery pack assembly is attached to or detached from an electric tool or a charger, and only attachment and detachment of the battery pack that cannot be used in a vehicle is disclosed.

### PRIOR ART DOCUMENT

(Patent Document 1) Korean Patent Application Publication No. 2014-010084

### DISCLOSURE

### Technical Problem

The present invention has been made in view of the above problems, and it is an object of the present invention to provide a battery pack configured such that battery modules constituting the battery pack are detachably attached thereto while being mountable in a vehicle.

It is another object of the present invention to provide a battery pack having a structure capable of monitoring a battery module in which fire has broken out or a battery module having a high possibility of fire outbreak and separating a battery module determined to be in an abnormal state from the battery pack.

### Technical Solution

In order to accomplish the above objects, a battery pack according to the present invention includes a pack case (100), a plurality of battery modules (200) received in the pack case (100), a busbar (300) configured to electrically connect the battery modules (200) to each other, and a module holding unit (400) configured to fix the battery module (200) to the pack case (100) or to separate the battery module (200) from the pack case (100).

Also, in the battery pack according to the present invention, the module holding unit (400) may include a first permanent magnet (410) mounted to the battery module (200), a second permanent magnet (420) disposed so as to face the first permanent magnet (410), a rotary shaft (430) having one side connected to the second permanent magnet (420), and a motor (440) connected to the rotary shaft (430), wherein the motor (440) may be repeatedly rotated by 180 degrees such that repulsive force and attractive force are alternately generated between the first permanent magnet (410) and the second permanent magnet (420), whereby the battery module (200) may be received in or separated from the pack case (100).

Also, in the battery pack according to the present invention, the pack case (100) may be provided with a support frame (111) disposed so as to cross the interior thereof, and the motor (440) may be fixed to the support frame (111).

Also, in the battery pack according to the present invention, each of the first permanent magnet (410) and the second permanent magnet (420) may be formed in the shape of a circular plate or a quadrangular plate and may be configured such that an N pole and an S pole are provided at one surface thereof in symmetry.

Also, in the battery pack according to the present invention, the motor (440) may be configured to be rotated according to a signal from a controller.

Also, in the battery pack according to the present invention, the pack case (100) may be provided at a bottom surface thereof with a door (122) configured to allow the battery module (200) to fall downwards.

Also, in the battery pack according to the present invention, the door (122) may be provided in the same number as the battery modules (200).

Also, in the battery pack according to the present invention, the pack case (100) may be further provided with a door turning portion (123) configured to turn the door (122) and a door opening and closing portion (124).

Also, in the battery pack according to the present invention, the door opening and closing portion (124) may be operated to switch a locked state of the door (122) to an unlocked state according to a signal from the controller.

Also, in the battery pack according to the present invention, each of the plurality of battery modules (200) may be provided with a sensor (210) configured to sense an abnormal state thereof.

Also, in the battery pack according to the present invention, the sensor (210) may be a temperature sensor.

In addition, the battery pack according to the present invention may further include a controller configured to receive a signal from the sensor (210) and to apply overcurrent to the busbar (300) in an abnormal state.

Also, in the battery pack according to the present invention, the busbar (300) may be provided with a notch type fuse (320).

In addition, the present invention provides a method of separating an abnormal battery module from the battery pack in a state in which the battery pack is mounted in a vehicle, the method including a first step of the controller receiving state information from each of the battery modules, a second step of determining whether the state information received in the first step corresponds to an abnormal state, and a third step of separating a battery module corresponding to the abnormal state from the battery pack, wherein, in the third step, the motor (440) is rotated such that repulsive force is generated between the first permanent magnet (410) mounted to the battery module (200) and the second permanent magnet (420) disposed so as to face the first permanent magnet (410).

Also, in the method according to the present invention, in the third step, a signal is transmitted to the door opening and closing portion (124) such that a locked state of the door (122) is switched to an unlocked state, and the method may further include applying overcurrent to the busbar (300).

### Advantageous Effects

As is apparent from the above description, a battery pack according to the present invention has an advantage in that a door configured to be opened and closed and a module holding unit configured to fix or unfix each battery module are provided at a pack case, whereby it is possible to separate an abnormal battery module from the pack case.

In addition, the battery pack according to the present invention has a merit in that a sensor is mounted to each battery module in order to monitor whether the battery module is normal or abnormal, and a determination is made as to whether to separate the battery module based on the result of monitoring, whereby accurate determination is possible.

Furthermore, the battery pack according to the present invention has an advantage in that, since the battery pack has a structure capable of separating an abnormal battery module from the pack case, it is possible to protect vehicle passengers at the time of explosion of the battery pack.

### DESCRIPTION OF DRAWINGS

FIG. 1 is a perspective view of a conventional battery pack assembly.

FIG. 2 is a perspective view of a battery pack according to a preferred embodiment of the present invention.

FIG. 3 is an exploded perspective view of the battery pack shown in FIG. 2.

FIG. 4 is an enlarged bottom perspective view of the battery pack shown in FIG. 2.

FIG. 5 is a partial sectional view of the battery pack shown in FIG. 2.

FIG. 6 is a partial plan view of the battery pack shown in FIG. 2.

FIG. 7 is a plan view of a fuse used in the battery pack according to the preferred embodiment of the present invention.

FIG. 8 is an enlarged perspective view illustrating the principle by which a module holding unit is operated in the battery pack shown in FIG. 2.

FIG. 9 is a sectional view illustrating that a battery module is separated from the battery pack shown in FIG. 2.

FIG. 10 is a perspective view illustrating that the battery module is separated from the battery pack shown in FIG. 2.

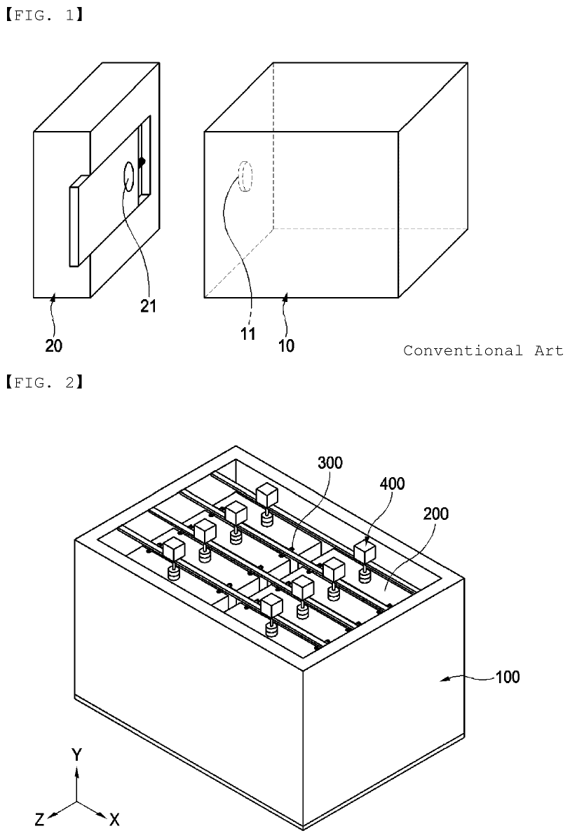

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, a battery pack configured such that selective separation of battery modules is possible according to the present invention and a method of separating an abnormal battery module from the battery pack will be described with reference to the accompanying drawings.

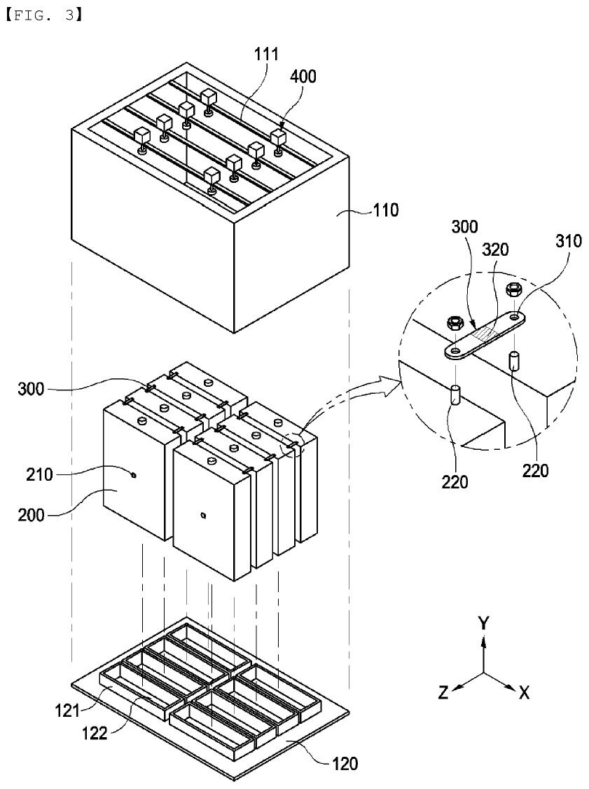

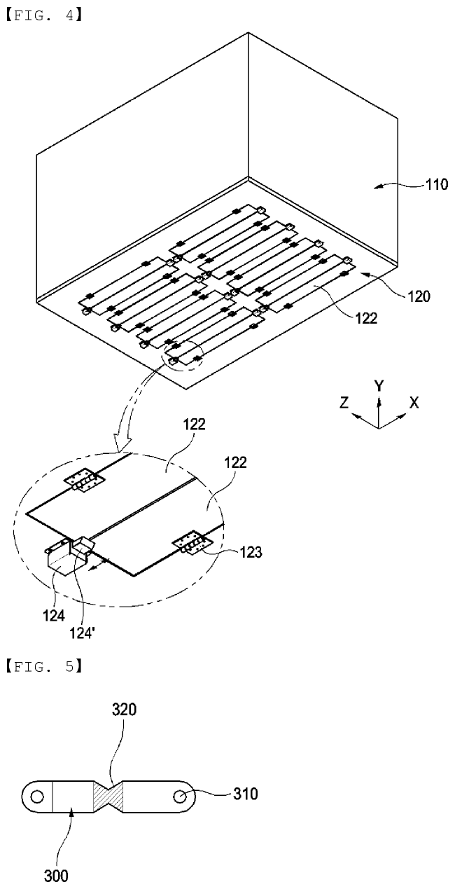

FIG. 2 is a perspective view of a battery pack according to a preferred embodiment of the present invention, FIG. 3 is an exploded perspective view of the battery pack shown in FIG. 2, and FIG. 4 is an enlarged bottom perspective view of the battery pack shown in FIG. 2.

As shown in FIGS. 2 to 4, the battery pack according to the preferred embodiment of the present invention includes a pack case 100, a plurality of battery modules 200, a busbar 300 configured to electrically connect the battery modules 200 to each other, a plurality of module holding units 400, and a controller (not shown).

Although a plurality of hexahedral battery modules 200 is shown as being erected in the figures, this is merely an example, and it is obvious that a wide surface of each of the battery modules may be disposed so as to face a bottom of the pack case 100.

First, the pack case 100 may be formed in the shape of a box configured to safely receive the plurality of battery modules 200, and may be constituted by a side case 110 configured to surround side surfaces of the battery modules 200 and a lower case 120 configured to support lower surfaces of the battery modules 200. Of course, the side case 110 and the lower case 120 may be integrally formed as a single case. Also, it is obvious that an upper cover may be provided, although not shown in the figures.

Meanwhile, a plurality of support frames 111 is provided at an upper part of the side case 110 at the inside thereof. Specifically, each support frame 111 is located so as to cross the interior of the side case 110, and opposite ends of the support frame are fixed to the inside of the side case 110. The support frames 111 are configured to fix a motor. In this regard, a description will follow.

The lower case 120 is provided at an upper surface thereof with a support plate 121 projecting by a predetermined height in a direction in which each battery module 200 is located. The support plate 121 supports lower end parts of four surfaces or two facing surfaces of the battery module 200 in order to inhibit movement of the battery module 200 due to external impact.

In addition, the lower case 120 is provided with a door 122 configured to open a predetermined part of the lower case, and a door turning portion 123 configured to turn the door 122 and a door opening and closing portion 124 are installed.

The door 122, the door turning portion 123, and the door opening and closing portion 124 are elements configured such that, when the battery modules are normally operated, the door 122 is closed, whereby the battery modules 200 remain received in the pack case 100, and when a specific battery module is abnormal, the door 122 is opened in order to separate the abnormal battery module from the pack case 100.

Consequently, it is preferable for the door 122 to be located at a lower surface of each battery module (200), and it is more preferable for the number of the doors to be equal to the number of the battery modules 200. Although the door 122 is shown as having a double door structure in the figures, this is merely an example, and the door may have a single door structure.

As an example, the door turning portion 123 may be a hinge, although the door turning portion is not particularly restricted as long as one side of the door turning portion 123 is fixed to the lower case 120 and the other side of the door turning portion is connected to the door 122 such that the door 122 can be turned by a predetermined angle.

The door opening and closing portion 124, which is configured to control opening and closing of the door 122, is provided at a lower surface of the lower case 120, more specifically at a position at which a latch 124′ of the door opening and closing portion 124 can support the side or corner of the door 122 to which the door turning portion 123 is not mounted.

As an example, the door opening and closing portion 124 may be implemented by a solenoid type electromagnetic door locking member, and the latch 124′ is moved forwards or backwards according to an external signal. The electromagnetic door locking member is known, and therefore a detailed description thereof will be omitted.

Next, the battery module 200 will be described. A plurality of battery cells is received in a module case with a cooling device, etc. in a state of being vertically or horizontally stacked.

Meanwhile, each of the battery cells may include a cell case having a pocket type receiving portion formed therein, an electrode assembly received in the cell case, an electrode tab, an electrode lead, and an insulative film.

The receiving portion of the cell case is formed using a laminate sheet constituted by an outer resin layer, a metal layer, and an inner resin layer.

The outer resin layer is located at an outer side of the cell case, and the outer resin layer may be made of a heat-resistant polymer that exhibits excellent tensile strength, resistance to moisture permeation, and resistance to air transmission such that the outer resin layer exhibits high heat resistance and chemical resistance while protecting the electrode assembly. As an example, the outer resin layer may be made of nylon or polyethylene terephthalate; however, the present invention is not limited thereto.

The metal layer, which abuts the outer resin layer, corresponds to a barrier layer configured to prevent moisture or various kinds of gas from permeating into the battery from the outside. An aluminum thin film, which is lightweight and easily shapeable, may be used as a preferred material for the metal layer.

The inner resin layer is disposed in direct contact with the electrode assembly, and therefore the inner resin layer must exhibit high insulation properties and high resistance to an electrolytic solution. In addition, the inner resin layer must exhibit high sealability in order to hermetically isolate the cell case from the outside, i.e. a thermally-bonded sealed portion between inner layers must exhibit excellent thermal bonding strength.

The inner resin layer may be made of a material selected from among a polyolefin-based resin, such as polypropylene, polyethylene, polyethylene acrylic acid, or polybutylene, a polyurethane resin, and a polyimide resin, which exhibit excellent chemical resistance and high sealability; however, the present invention is not limited thereto, and polypropylene, which exhibits excellent mechanical properties, such as tensile strength, rigidity, surface hardness, and impact resistance, and excellent chemical resistance, is the most preferably used.

The electrode assembly, which is received in the cell case, may be a jelly-roll type electrode assembly, which is configured to have a structure in which a long sheet type negative electrode and a long sheet type positive electrode are wound in the state in which a separator is interposed therebetween, a stacked type electrode assembly including unit cells, each of which is configured to have a structure in which a rectangular positive electrode and a rectangular negative electrode are stacked in the state in which a separator is interposed therebetween, a stacked and folded type electrode assembly, which is configured to have a structure in which unit cells are wound using a long separation film, or a laminated and stacked type electrode assembly, which is configured to have a structure in which unit cells are stacked in the state in which a separator is interposed therebetween and are then attached to each other; however, the present invention is not limited thereto.

Specifically, the negative electrode is manufactured by applying a slurry mixture of a negative electrode active material and a binder to a negative electrode current collector.

As the negative electrode active material, for example, there may be used carbon, such as a non-graphitizing carbon or a graphite-based carbon; a metal composite oxide, such as LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, Group 1, 2, and 3 elements of the periodic table, halogen; 0<x≤1; 1≤y≤3; 1≤z≤8); lithium metal; a lithium alloy; a silicon-based alloy; a tin-based alloy; a metal oxide, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, or Bi₂O₅; a conductive polymer, such as polyacetylene; a Li—Co—Ni-based material; or a Si-based material, such as Si, SiO, SiO₂, or a mixture thereof; however, the present invention is not limited thereto.

The positive electrode is manufactured by applying a slurry mixture of a positive electrode active material and a binder to a positive electrode current collector.

The positive electrode active material may be constituted, for example, by a layered compound, such as a lithium cobalt oxide (LiCoO₂) or a lithium nickel oxide (LiNiO₂), or a compound substituted with one or more transition metals; a lithium manganese oxide represented by the chemical formula Li₁₊ₓMn₂₋ₓO₄ (where x=0 to 0.33) or a lithium manganese oxide, such as LiMnO₃, LiMn₂O₃, or LiMnO₂; a lithium copper oxide (Li₂CuO₂); a vanadium oxide, such as LiV₃O₈, LiFe₃O₄, V₂O₅, or Cu₂V₂O₇; a Ni-sited lithium nickel oxide represented by the chemical formula LiNi₁₋ₓMₓO₂ (where M=Co, Mn, Al, Cu, Fe, Mg, B, or Ga, and x=0.01 to 0.3); a lithium manganese composite oxide represented by the chemical formula LiMn₂₋ₓMₓO₂ (where M=Co, Ni, Fe, Cr, Zn, or Ta, and x=0.01 to 0.1) or the chemical formula Li₂Mn₃MO₈ (where M=Fe, Co, Ni, Cu, or Zn); LiMn₂O₄ in which a portion of Li in the chemical formula is replaced by alkaline earth metal ions; a disulfide compound; or Fe₂(MoO₄)₃; however, the present invention is not limited thereto.

Meanwhile, each of the negative electrode current collector and the positive electrode current collector is constituted by a portion to which the slurry including the active material is applied and an uncoated portion to which no slurry is applied. The uncoated portion is cut or a separate conductive member is connected to the uncoated portion by ultrasonic welding to form the electrode tab.

The electrode lead is connected to the electrode tab by spot welding, and the insulative film is located around the electrode lead.

Meanwhile, it is preferable for a sensor 210 configured to sense a normal state or an abnormal state of the battery module 200 to be further provided at an outer surface or an inner surface of the battery module. The battery module 200 is repeatedly charged and discharged. Due to various internal or external causes, fire may break out in a specific battery module 200, or the temperature of the battery module may excessively increase and exceed a normal temperature range thereof.

The sensor 210, which is a sensor configured to sense whether the battery module 200 is abnormal, may be a temperature sensor capable of measuring the temperature of the battery module.

For example, when the measured temperature exceeds a normal operating temperature range of the battery module, it may be determined that the battery module having the sensor mounted thereto has overheated, whereby there is a high possibility of fire outbreak or fire has broken out.

Next, the busbar 300 will be described. The busbar 300 is configured to connect the plurality of battery modules 200 to each other in series or in parallel. A fastening hole 310 for electrical connection with an external terminals 220 of the battery module 200 may be provided in each of opposite edges of the busbar, and a fuse 320 may be provided in the middle of the busbar so as to be cut when overcurrent is applied thereto.

For example, when each of opposite ends of the busbar is made of copper (Cu), which has relatively low resistance and a high melting point, and the fuse 320 provided in the middle of the busbar is made of aluminum (Al), which has higher resistance than copper (Cu) and a low melting point, the fuse 320 made of aluminum (Al) is cut when overcurrent is applied thereto.

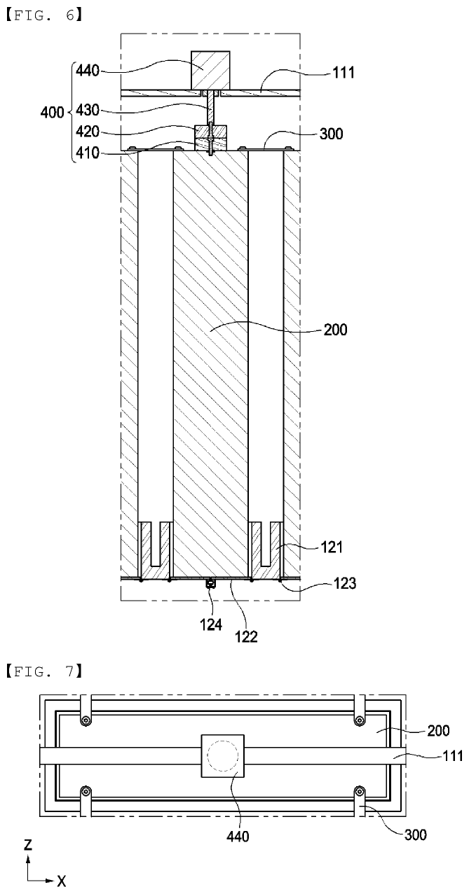

FIG. 5 shows a modification of the busbar used in the battery pack according to the present invention. As shown in FIG. 5, a notch may be formed in the fuse 320. When the notch is formed in the fuse 320, the area of the fuse through which current flows is reduced, whereby resistance is increased, and therefore temperature is rapidly increased. As a result, the fuse 320 may be rapidly cut when overcurrent is applied thereto.

Referring back to FIGS. 2 to 4, the module holding unit 400 is configured to fix the battery module 200 to the pack case 100 or to separate the battery module from the pack case 100. A detailed description thereof will follow.

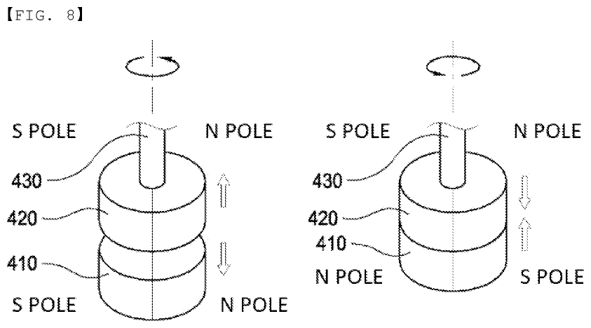

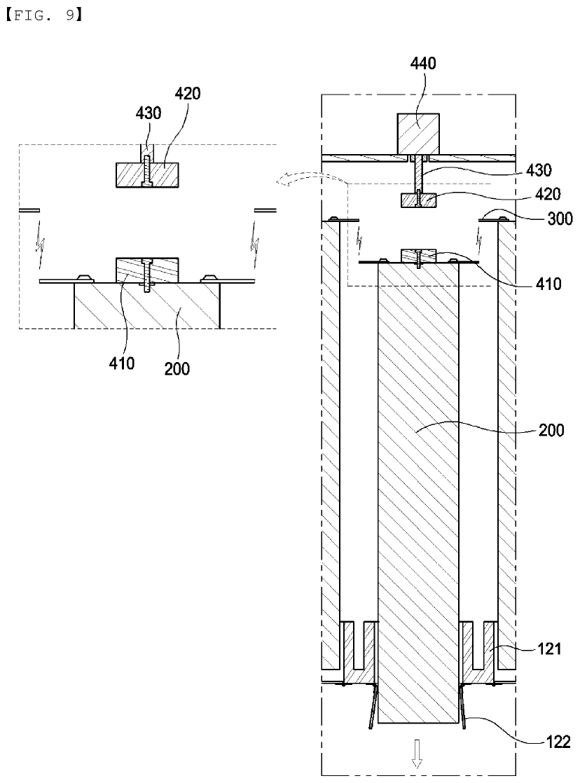

FIG. 6 is a partial sectional view of the battery pack shown in FIG. 2, FIG. 7 is a partial plan view of the battery pack shown in FIG. 2, and FIG. 8 is an enlarged perspective view illustrating the principle by which the module holding unit is operated in the battery pack shown in FIG. 2.

Referring to FIGS. 6 and 7, the module holding unit 400 may include a first permanent magnet 410 mounted to the battery module 200, a second permanent magnet 420 disposed so as to face the first permanent magnet 410, a rotary shaft 430 having one side connected to the second permanent magnet 420, and a motor 440 connected to the rotary shaft 430.

Specifically, each of the first permanent magnet 410 and the second permanent magnet 420 is formed in the shape of a circular plate or a quadrangular plate and is configured such that an N pole and an S pole are disposed in symmetry. When the S pole and the N pole of the second permanent magnet 420 are located respectively above the N pole and the S pole of the first permanent magnet 410, therefore, attractive force acts therebetween. When the second permanent magnet 420 is rotated 180 degrees in a horizontal direction and the N pole and the S pole of the second permanent magnet 420 are located respectively above the N pole and the S pole of the first permanent magnet 410, on the other hand, repulsive force acts therebetween.

The rotary shaft 430 and the motor 440 are configured to adjust the positions of the N pole and the S pole of the second permanent magnet 420. The motor 440 may be seated on an upper part of the support frame 111 of the pack case 100. When an upper cover is provided, however, the motor may be fixed to the upper cover.

Here, the motor 440 is not particularly restricted as long as the motor is rotatable according to a signal from the controller. As an example, the motor may be a stepping motor. The controller may be provided in the battery pack 100, or an integrated stepping motor having a driving controller mounted therein may be used.

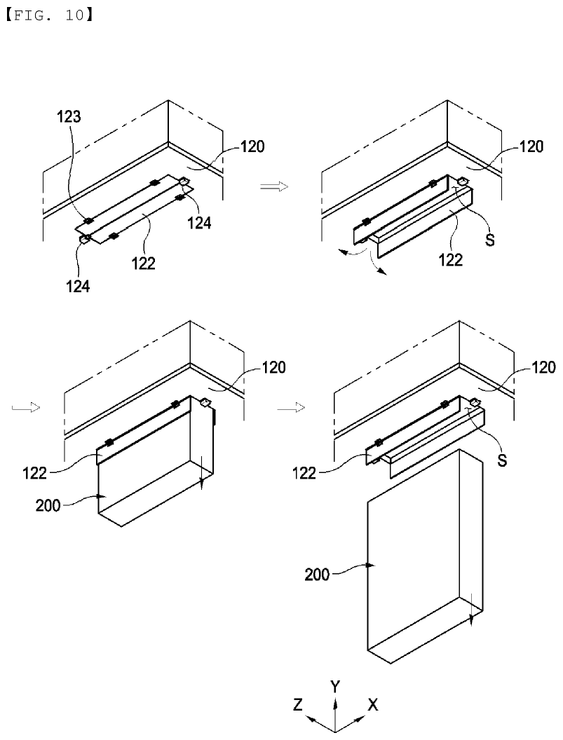

FIG. 9 is a sectional view illustrating that a battery module is separated from the battery pack shown in FIG. 2, and FIG. 10 is a perspective view illustrating that the battery module is separated from the battery pack shown in FIG. 2.

The principle by which the battery module is separated from the battery pack will be described with reference to FIGS. 9 and 10.

The sensor 210 mounted to each of the plurality of battery modules 200 measures the temperature of a corresponding one of the battery modules. When the temperature of a specific one of the battery modules 200 increases to a predetermined temperature or higher, the controller transmits a signal to the door opening and closing portion 124 and/or the motor 440.

Specifically, the signal is transmitted to the door opening and closing portion 124 such that the latch 124′ supporting the door 122 is moved backwards and the door 122 is turned downwards. In addition, the signal is transmitted in order to rotate the motor 440 such that repulsive force acts between the first permanent magnet 410 and the second permanent magnet 420 mounted to the upper part of the battery module 200.

As a result, the abnormal battery module 200 falls downwards from the pack case 100 through an opening S by weight.

Meanwhile, when the temperature of the specific battery module 200 increases to a predetermined temperature or higher, it is more preferable to transmit a signal for overcurrent application to the battery module 200 such that the fuse 320 of the busbar 300 is rapidly cut.

A method of separating an abnormal battery module from the battery pack in the state in which the battery pack is mounted in a vehicle may include a first step of the controller receiving state information from each of the battery modules, a second step of determining whether the state information received in the first step corresponds to an abnormal state, and a third step of separating a battery module corresponding to the abnormal state from the battery pack.

In the third step, the motor 440 is rotated such that repulsive force acts between the first permanent magnet 410 mounted to the battery module 200 and the second permanent magnet 420 disposed so as to face the first permanent magnet 410, and a signal is transmitted to the door opening and closing portion 124 such that a locked state of the door 122 is switched to an unlocked state, as previously described. In addition, a step of applying overcurrent to the busbar 300 may be further included, as needed.

The present invention has been described above with reference to specific embodiments. However, those skilled in the art to which the present invention pertains will appreciate that various applications and modifications are possible within the category of the present invention based on the above description.

### DESCRIPTION OF REFERENCE SYMBOLS

100: Pack case
110: Side case
111: Support frame
120: Lower case
121: Support plate 122: Door
123: Door turning portion
124: Door opening and closing portion 124′: Latch
200: Battery module
210: Sensor 220: External terminal
300: Busbar
310: Fastening hole
320: Fuse
400: Module holding unit
410: First permanent magnet
420: Second permanent magnet
430: Rotary shaft
440: Motor
S: Opening

1. A battery pack comprising:
a pack case;
a plurality of battery modules received in the pack case;
a busbar configured to electrically connect the plurality of battery modules to each other; and
a module holder configured to fix at least one battery module of the plurality of battery modules to the pack case or to separate the at least one battery module from the pack case.

2. The battery pack according to claim 1, wherein the module holding unit comprises:
a first permanent magnet mounted to the at least one battery module;
a second permanent magnet disposed to face the first permanent magnet;
a rotary shaft having a first end connected to the second permanent magnet; and
a motor connected to a second end of the rotary shaft, and
wherein the motor is rotated by 180 degrees such that repulsive force and attractive force are generated between the first permanent magnet and the second permanent magnet, whereby the at least one battery module is received in or separated from the pack case.

2. The battery pack according to claim 2, wherein the pack case is provided with a support frame disposed to cross an interior thereof, and
wherein the motor is fixed to the support frame.

4. The battery pack according to claim 2, wherein each of the first permanent magnet and the second permanent magnet is a circular plate or a quadrangular plate and is configured such that an N pole and an S pole are provided at one surface thereof in symmetry.

5. The battery pack according to claim 2, wherein the motor is configured to be rotated according to a signal from a controller.

6. The battery pack according to claim 1, wherein the pack case is provided at a bottom surface thereof with at least one door configured to allow the at least one battery module to fall downwards.

7. The battery pack according to claim 6, wherein the at least one door is provided in a same number as the plurality of battery modules.

8. The battery pack according to claim 6, wherein the pack case is further provided with a door turning portion configured to turn the at least one door and a door opening and closing portion.

9. The battery pack according to claim 8, wherein the door opening and closing portion is operated to switch a locked state of the at least one door to an unlocked state according to a signal from a controller.

10. The battery pack according to claim 1, wherein each of the plurality of battery modules is provided with a sensor configured to sense an abnormal state thereof.

11. The battery pack according to claim 10, wherein the sensor is a temperature sensor.

12. The battery pack according to claim 10, further comprising a controller configured to receive a signal from the sensor and to apply overcurrent to the busbar.

13. The battery pack according to claim 12, wherein the busbar is provided with a notch type fuse.

14. A method of separating an abnormal battery module from the battery pack according to claim 1 in a state in which the battery pack is mounted in a vehicle, the method comprising:
receiving state information from each of the plurality of battery modules;
determining whether the received state information corresponds to an abnormal state; and
separating a battery module corresponding to the abnormal state from the battery pack,
wherein a motor is rotated such that repulsive force is generated between a first permanent magnet mounted to the battery module and a second permanent magnet disposed to face the first permanent magnet.

15. The method according to claim 14, wherein a signal is transmitted to a door opening and closing portion in a bottom of the pack case such that a locked state of a door is switched to an unlocked state, and
applying overcurrent to the busbar.
